(19) United States
(12) Patent Application Publication
(10) Pub. No.: US 2008/0078876 A1
(43) Pub. Date: Apr. 3, 2008

(54) COMPOSITE RESIN WINDOW FRAME CONSTRUCTIONS FOR AIRPLANES

(76) Inventors: Phillip D. Baggette, Sammamish, WA (US); Richard W. Brigman, Everett, WA (US); Bernhard Dopker, Bellevue, WA (US); Robert W. Johnson, Kirkland, WA (US); Jeffery P. Sandys, Shoreline, WA (US)

Correspondence Address: OSTRAGER CHONG FLAHERTY & BROITMAN, P.C., 570 LEXINGTON AVENUE, FLOOR 17, NEW YORK, NY, 10022-6894, US

(21) Appl. No.: 11/464,517

(22) Filed: Aug. 15, 2006

(51) Int. Cl. B64C 1/14

(52) U.S. Cl. 244/129.3

(57) ABSTRACT

A composite resin window frame for installation in a composite resin airplane fuselage has an inner flange for receiving and securely affixing an aircraft window transparency and an outer flange adapted for connection to the airplane fuselage structure. The frame has a generally flat configuration which does not require any additional strength enhancing member such as an additional flange perpendicular to the structure. The composite resin window frame has sufficient strength to securely affix a window transparency to a composite resin fuselage.

### BACKGROUND OF THE INVENTION

1. Field of the Invention

The present invention provides manufacturing improvements for airplanes utilizing composite resin window frame constructions.

2. Prior Art

Airplane window frame assemblies must be sufficiently strong to hold a window transparency in place while compensating for any loss of strength where the fuselage skin is pierced to receive the transparency. Airplane window frame assemblies are generally fabricated from metal constructions that offer strength but which traditionally suffer from weight concerns and corrosion deficiencies.

Aluminum fuselages on current airplanes have forged window frames in combination with window belts having localized doublers around the windows. The upstanding flange used in prior art aluminum frames prevents skin buckling through and near the window cutout. The upstanding flange on such window frames is commonplace on aluminum airplanes and it also serves to guide installation of the window into place during assembly.

In contrast to forging the frame out of aluminum, fabricating the upstanding leg with composite resin is comparatively difficult and expensive because its shape is difficult to mold. Its profile is generally a T-shaped part which can be difficult to remove from a composite resin mold.

Composite frame assemblies utilizing molded resin and the like have been investigated but have heretofore exhibited additional problems. For example, published PCT application WO 2005/115728 utilizes composite resin in a window frame assembly but the construction profile requires an upstanding or vertical leg in order to stiffen the window frame. This additional flange structure adds weight, cost and complication to the frame and its fabrication. The upstanding leg also presents manufacturing difficulties due to its more complex shape.

### BACKGROUND OF THE INVENTION—OBJECTS AND ADVANTAGES

One extraordinary advantage of the present composite resin frame design is the removal of the upstanding leg which significantly reduces the weight of the part and also eases the difficulty of making the window frame with composite resins.

Another outstanding feature of the present invention is the recognition that an airplane fuselage skin can be utilized to carry the load which is displaced when the fuselage is pierced to provide a transparency aperture. The composite window frame carries the transparency and any associated loads.

Heretofore, no other methods have existed to eliminate the need for the upstanding reinforcement leg in prior art composite window frame assemblies. The present design and method provides a lower risk, lighter weight, less costly solution to using composite window frames in conjunction with a composite airplane fuselage.

The present design also provides a flatter window frame system or assembly, thereby enabling easier fabrication and installation. Furthermore, any required skin gage increase can be localized at the site of the window frame installation.

The present composite resin windowframe design also ensures that shear loads stay in the composite skin structure. Additionally, the composite resin window frame skin is able to carry the hoop load and is therefore more weight efficient for that reason as well.

To provide this functionality, the composite resin window frame assembly relies on the strength of a composite fuselage skin and stringers loaded with and retaining the frame and window.

The present design for a composite resin window frame does not require the upstanding reinforcement leg used in prior art frames. The new design was achieved by performing load analyses on the new frame, whereby it has been discovered that the conventional upstanding leg or flange is unnecessary to stabilize the skin. The load can instead be stabilized through use of a thicker composite resin skin in proximity to the window aperture.

Consequently, removal of the upstanding leg has resulted in the aforementioned benefits, particularly a significant reduction in the weight of the window frame while simplifying the frame manufacturing process.

### SUMMARY

A composite resin window frame for installation in a composite resin airplane fuselage and a method of manufacturing it is provided. The frame has an inner flange for receiving and securely affixing an aircraft window transparency and an outer flange adapted for connection to an airplane fuselage structure. The composite resin frame is sufficiently strong that additional strength enhancing members such as the upstanding leg or flange structures seen in the prior art are unnecessary. Without a perpendicular reinforcement member such as an upstanding leg or flange, the subject frame in a typical installation has a generally flat configuration with a cross-sectional thickness of, approximately, 0.3 to 0.6 cm and a cross-sectional width of approximately 5.5 to 6.0 cm as measured from its inner flange edge to the outer flange edge. Such a composite resin window frame will securely affix a window transparency to a composite resin fuselage and carry compression, tension and shear forces it may experience and transmit these to the composite resin fuselage.

The composite resin window frame is made from a combination of reinforcing fibers in a curable resin matrix. The curable resin matrix is usually a thermoplastic resin or a thermosetting resin. A typical curable resin matrix is epoxy resin combined with carbon or glass reinforcing fibers or mixtures.

The composite resin window frame is combined with other elements to provide a window frame assembly for an airplane. The composite resin window frame has one or more airplane window transparencies affixed to its inner flange, the frame and window combination is installed in a window aperture of an airplane fuselage, and the outer flange of the frame is securely affixed to the composite fuselage. This carries and transmits all of the loads it experiences to the composite resin fuselage.

Although the window transparency may be a single transparency, it is often a laminate of two or more individual transparencies. A typical window transparency may be a stretched acrylic transparency. The window transparency is affixed to the inner flange of the composite window frame by means of conventional retaining clips and a suitable seal. The outer flange of the composite resin window frame is affixed to the composite fuselage of the airplane by means of conventional mechanical fasteners.

A method of manufacturing the composite resin window frame involves loading a composite matrix of curable plastic resin and reinforcing fiber material in a frame molding tool of predetermined shape and dimension and molding the composite resin frame, usually with sufficient heat and pressure, to cure the molded part which may then be cooled to provide the composite resin window frame part.

Suitable manufacturing processes include prepreg hand lay-up processes, as well as any processes selected from hot drape forming, tape lamination, fabrication with sheet molding compound, tow tape placement, slit tape placement, resin transfer molding, liquid resin infusion, resin film infusion, bulk resin infusion, reinforced thermal plastic lamination, resin injection molding, compression molding, resin transfer molding and the like.

Also contemplated is a manufacturing method in which the frame-molding tool is preloaded with a pre-fabricated insert. Such inserts would include a resin matrix insert, a metallic insert or a metal-composite hybrid insert.

### DRAWINGS—FIGURES

FIG. 1 is a plan view of the composite resin window frame.

FIG. 2 is an end elevation view of the composite resin window frame of FIG. 1.

FIG. 3 is a side elevation view of the composite resin window frame of FIG. 1.

FIG. 4 is a cross-sectional view of the composite resin window frame of FIG. 1, at position i-i.

FIG. 5 is a cross-sectional view of the composite resin window frame assembly.

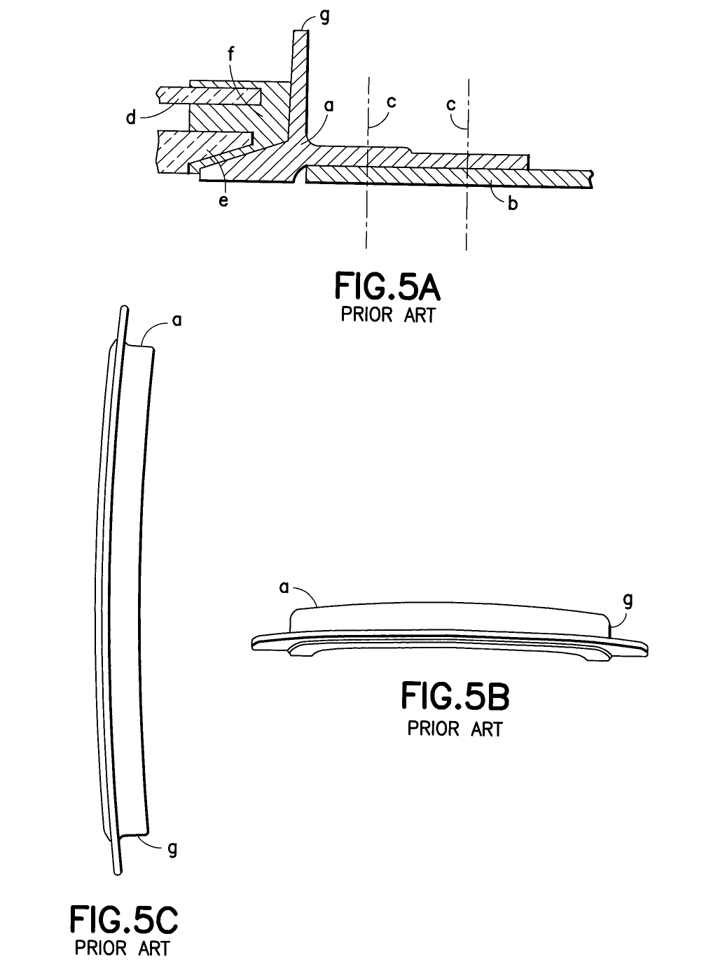

Prior Art FIGS. 5A, 5B and 5C depict prior art embodiments of a composite resin window frame having an upstanding reinforcement leg.

### DETALED DESCRIPTION

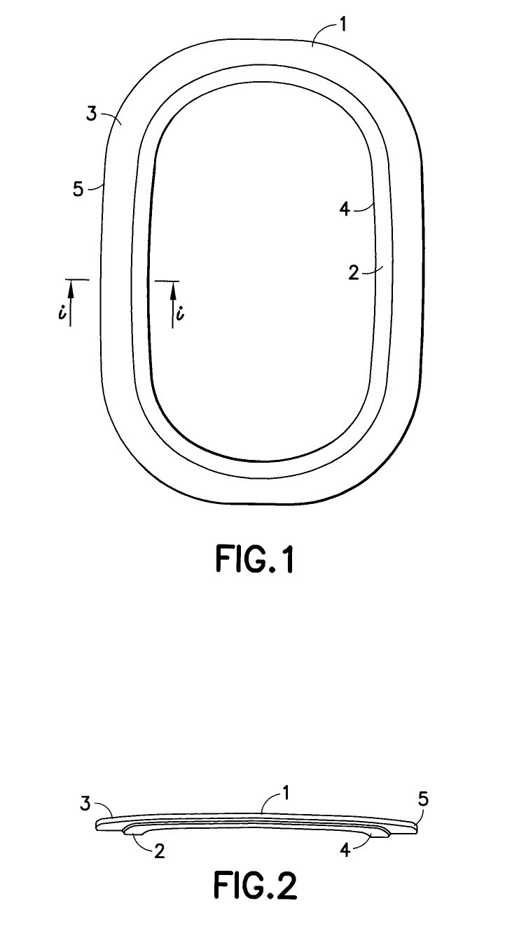

A composite resin window frame 1 is depicted in FIG. 1. As is standard in the manufacture of airplanes, the composite window frame has a generally ovoid shape with typical overall dimensions of about 35-40 cm by 55-60 cm. Other shapes and sizes for a variety of fuselage apertures may be readily adapted in accordance with the present method. In FIG. 1, inner flange 2 and inner flange edge 4 will retain a window transparency with appropriate retaining clip and seal. Outer flange 3 having outer flange edge 5 is utilized to attach the composite resin frame 1 to an airplane fuselage assembly.

FIG. 2 reveals the generally flatter and thinner aspects of composite resin window frame 1, particularly in comparison to Prior Art FIG. 5B. Upstanding leg or flange structure g in the prior art design of FIG. 5B has been eliminated in composite resin window frame 1 of the present invention.

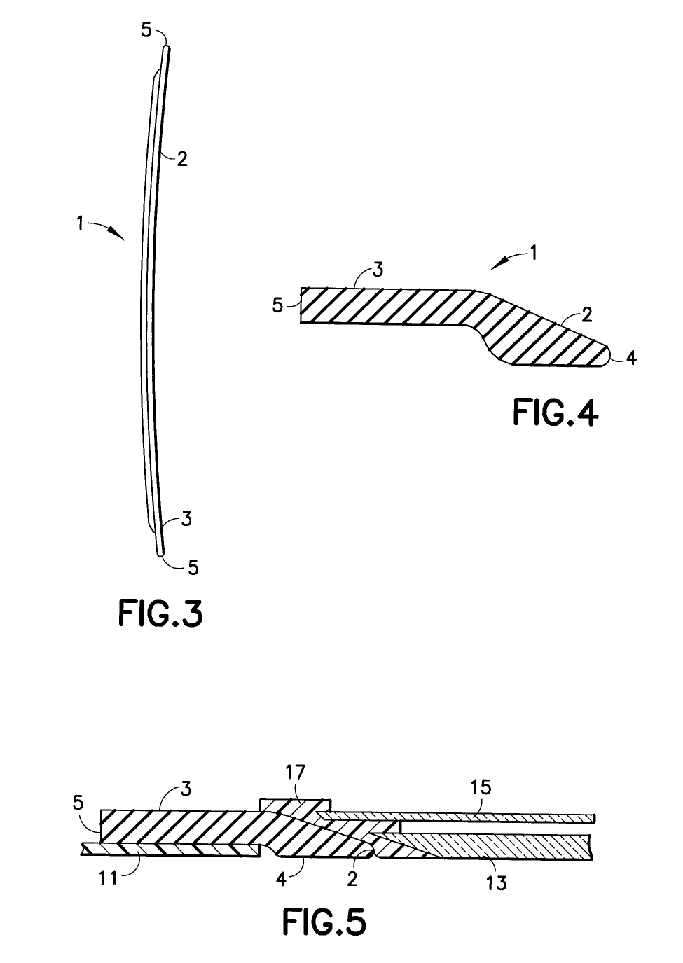

FIG. 3 reveals the generally flatter and thinner aspects of composite resin window frame 1, particularly in comparison to Prior Art FIG. 5C. Again it is readily apparent that the present composite window frame 1 has eliminated flange g in the prior art design of FIG. 5C.

FIG. 4 depicts a cross-sectional view of the composite resin window frame of FIG. 1, at position i-i.

FIG. 5 depicts a cross-sectional view of the composite resin window frame assembly wherein composite resin window frame 1 is adjoined to fuselage skin 11. Window transparencies 13 and 15 are attached to frame 1 by means of mechanical clips and seal 17. The transparency window is preferably stretched acrylic or laminated stretch acrylic, but may also be single- or multi-pane glass or alternatives. FIGS. 2-5 each also depict inner flange 4 and inner flange edge 2 as well as outer flange 3 and outer flange edge 5.

Prior Art FIG. 5A depicts the cross-section of a composite resin window frame construction a having vertical flange g, which the design of the present invention is designed to eliminate. FIG. 5A also depicts fuselage skin b, fastened to the composite frame with rivets positioned as indicated by c. Window transparencies d and e are secured to the frame by means of sealant f.

Prior Art FIG. 5B depicts an end elevation view of a window frame a having elongated flange g.

Prior Art FIG. 5C depicts a side elevation view of a window frame a having elongated flange g.

The present invention recognizes that the airplane fuselage skin can be utilized to carry the loads associated with stresses induced by skin-piercing apertures in the fuselage, where the composite resin window frame carries the transparency and its associated load. The subject composite window frame design allows for a composite fuselage barrel to function effectively without the necessity for conventional strength enhancement, such as that provided in prior window frame designs utilizing the up-standing reinforcement leg discussed previously. The composite window frame relies on the strength of the composite fuselage skin and associated stringers to bear the necessary loads while retaining the window transparencies in place.

Stress and compression analyses confirmed that the present composite resin window frame design achieved successful results without resorting to the use of a conventional, strength-enhancing upstanding leg, thereby benefiting from both weight and cost savings. Furthermore, it will be recognized that the advantages provided by the subject composite resin window frame assembly would apply equally well to other apertures in the fuselage of an airplane. Another benefit of manufacturing the subject composite resin frame is that there is no need to scallop the fuselage skin for installation.

The composite resin window frame and assembly may be fabricated in accordance with the following procedures and several different material and manufacturing options may be utilized or combined. The manufacturing process described for the composite resin frame is not limited to any single composite manufacturing method, rather, any number of approaches can be used.

A composite window frame of the present design may be made of either thermosetting or thermoplastic resin. Also, many different reinforcing fibers can be used in the resin matrix including glass and carbon fibers or combinations of these or other fibers used to reinforce the composite matrix.

In accordance with conventional composite resin manufacturing techniques, the selected resin and reinforcing fibers can be combined ahead of time, as in a so-called prepreg hand lay-up process. Other suitable methods include hot drape forming, tape lamination, fabrication with sheet molding compound, tow or slit tape placement, resin transfer molding, liquid resin infusion, resin film infusion, bulk resin infusion and reinforced thermal plastic lamination. Alternatively, the resin and fibers can be combined during molding operations such as resin infusion, resin injection molding, compression molding or resin transfer molding. Those skilled in the art will recognize that the method of the invention may be readily modified to incorporate pre-fabricated inserts, metallic inserts, and inserts comprising metal/composite hybrid structures.

The manufacturing methods described above may be enhanced by utilizing stress analysis techniques to design, refine and fabricate a variety of suitable composite resin window frames for use in combination with a composite fuselage, thereby providing stronger window frames while saving weight and cost. Since the composite resin window frame relies on the strength of the composite fuselage skin and associated stringers to distribute the shear loads adequately while still retaining the window, the load stays in the composite skin.

A typical composite window frame of the present design will have a generally oval shape. Overall dimensions across the frame are about 55-60 cm in the long dimension and have a narrower dimension of about 35-40 cm. The composite frame has a width of about 5-6 cm in the region depicted by position i-i in FIG. 1. Thus the cross-section depicted in FIG. 4 is about 0.60 cm thick, which is in marked contrast to the thickness of about 1.0 cm for the prior art window frame skin flange depicted in FIG. 5C and its 2.5 cm upstanding flange a. Composite resin frames for fuselage apertures of varying sizes can be readily fabricated with the present method of manufacture.

In one embodiment of the manufacturing process useful for producing the subject composite window frame, prepreg material is selected and cut to size for a particular part configuration, placed in a cure tool of desired shape and dimension and cured using heat and pressure.

An alternative method of fabrication involves tow prepreg or slit tape placement using an advanced fiber placement head which positions the prepreg in the molding tool and thereafter cures the resin composite using heat and pressure.

Another alternative method of fabrication involves resin transfer molding utilizing a dry fiber braid and resin. The braid is placed in a matched die tool; the resin is then injected into the tool and cured using heat and pressure. Another alternative method of fabrication involves liquid resin infusion wherein dry fiber braid is placed in the part tool; the braid is infused with the resin and cured using heat and pressure. In a vacuum-assisted resin infusing method, dry woven graphite is preformed and positioned over inexpensive aluminum tooling prior to curing the frame.

Other alternative methods include liquid film infusion and bulk resin infusion wherein dry fiber braid is placed in the part tool, the braid is infused with the resin film and cured using heat and pressure.

A method of reinforced thermal plastic lamination involves cutting a thermal plastic prepreg blank to appropriate size, heating the blank in an oven, forming the hot blank in a press, cooling the part and removing it from the press. Alternatively, cut plies can be stacked and placed on a consolidation tool. Consolidation can then be accomplished with heat and pressure, as in an autoclave or press method.

The following examples illustrate the invention and are not intended to limit the general applicability of the subject method.

### EXAMPLE 1

A composite window frame of the present invention was made by compression molding the frame in a molding tool. The molding tool produced a composite window frame having the shape and dimensions of the frame depicted in FIGS. 1-4. Hexcel compression molding material HexMC AS4 fiber was chopped into pieces, fitted into the frame mold and combined with Hexcel 8552 curable epoxy resin. After molding, curing and cooling, a composite resin window frame was thereby produced.

### EXAMPLE 2

Another composite resin window frame part of similar size and shape was fabricated using an intermediate modulus compression molding material, Toray BMS 8-276 carbon fiber epoxy prepreg tape material in accordance with the manufacturer's instructions. After molding, curing and cooling, another composite resin window frame of the present invention was thereby produced.

### EXAMPLE 3

Composite resin window frames made in accordance with the foregoing examples were converted into window frame assemblies by combining each of the frames with acrylic transparencies by means of clips and a rubber seal and installing the combined assemblies in composite fuselage apertures of sufficient size to receive and complete an integrated frame-window-fuselage assembly. Stress and load analyses confirmed that the frames carried and transmitted the loads satisfactorily to the surrounding fuselage skin structure.

1. A composite resin window frame for installation in a composite resin airplane fuselage, said frame comprising an inner flange for receiving and securely affixing an aircraft window transparency and an outer flange adapted for connection to the airplane fuselage structure; said frame having a generally flat configuration in the absence of a perpendicular reinforcement member, said composite resin window frame having sufficient strength to securely affix said window transparency to said composite resin fuselage in the absence of any additional strength enhancing member.

2. A composite resin window frame as in claim 1, wherein said generally flat configuration with a cross-sectional thickness of, approximately, 0.3 to 0.6 cm and a cross-sectional width of approximately 5.5 to 6.0 cm measured from an inner flange edge to an outer flange edge.

3. A composite resin window frame as in claim 1, wherein said composite resin is a combination of reinforcing fibers in a curable resin matrix

4. A composite resin window frame as in claim 1, wherein said curable resin matrix is a thermoplastic resin.

5. A composite resin window frame as in claim 1, wherein said curable resin matrix is a thermosetting plastic resin.

6. A composite resin window frame as in claim 5, wherein said curable resin matrix is epoxy resin.

7. A composite resin window frame as in claim 1, wherein said reinforcing fibers are selected from the group of carbon and glass fibers.

8. A composite resin window frame as in claim 1, wherein said frame is manufactured by compression molding.

9. A composite resin window frame as in claim 1, wherein said frame is manufactured by a prepreg hand lay-up method.

10. A composite resin window frame assembly for an airplane comprising the composite resin window frame of claim 1 having one or more airplane window transparencies affixed to the inner flange, said frame and window combination installed in a window aperture of an airplane fuselage, whereby the outer flange of said frame is securely affixed to said composite fuselage and whereby said composite resin window frame assembly carries and transmits its compression, shear and stress loads to said composite resin fuselage.

11. A composite resin window frame assembly as in claim 10, wherein said window transparency is comprises a laminate of two or more individual transparencies.

12. A composite resin window frame assembly as in claim 10, wherein said window transparency is a stretched acrylic transparency

13. A composite resin window frame assembly as in claim 10, wherein said window transparency is affixed to said inner flange of said window frame by means of a sealant.

14. A composite resin window frame assembly as in claim 10, wherein said sealant is rubber sealant.

15. A composite resin window frame assembly as in claim 10, wherein said outer flange is affixed to the composite fuselage of the airplane by means of mechanical fastening means.

16. A method of manufacturing a composite resin window frame for installation in a composite resin fuselage of an airplane, the composite resin window frame having an inner flange for receiving and securely affixing an aircraft window transparency and an outer flange adapted for connection to the airplane fuselage, in the absence of any additional strength enhancing member, comprising the steps of:
a. loading a composite matrix of curable plastic resin and reinforcing fiber material in a frame molding tool of predetermined shape and dimension;
b. molding said composite resin frame with sufficient heat and pressure to cure said molded part; and
c. cooling said molded part to provide a composite resin window frame part.

17. A method of manufacturing a composite resin window frame as in claim 16 wherein said molding step is accomplished by a prepreg hand lay-up process.

18. A method of manufacturing a composite resin window frame as in claim 16 wherein said molding step is accomplished by a process selected from hot drape forming, tape lamination, fabrication with sheet molding compound, tow tape placement, slit tape placement, resin transfer molding, liquid resin infusion, resin film infusion, bulk resin infusion, reinforced thermal plastic lamination, resin injection molding, compression molding and resin transfer molding.

19. A method of manufacturing a composite resin window frame as in claim 16 wherein said plastic resin is curable epoxy resin.

20. A method of manufacturing a composite resin window frame as in claim 16 wherein said reinforcing fiber is carbon or glass fiber and mixtures thereof.

21. A method of manufacturing a composite resin window frame as in claim 16 wherein frame molding tool is preloaded with a pre-fabricated insert comprising a resin matrix insert, a metallic insert or a metal-composite hybrid insert.

22. A composite resin window frame assembly as in claim 15, wherein said fastening means are mechanical rivets.
